(19) United States
(12) Patent Application Publication
(10) Pub. No.: US 2026/0199841 A1
(43) Pub. Date: Jul. 16, 2026

(54) CARBON MOLECULAR SIEVES AND METHODS FOR MAKING THE SAME

(71) Applicant: Dow Global Technologies LLC, Midland, MI (US)

(72) Inventors: Junqiang Liu, Manvel, TX (US); Jmie M. Weishuhn, Bay City, MI (US); Qichun Wan, Midland, MI (US); Tie Sun, Midland, MI (US); Dean M. Millar, Midland, MI (US); Kurt A. Koppi, Midland, MI (US)

(73) Assignee: Dow Global Technologies LLC, Midland, MI (US)

(21) Appl. No.: 19/137,888

(22) PCT Filed: Dec. 8, 2023
(86) PCT No.: PCT/US2023/083081

§ 371 Date: Jun. 11, 2025

Related U.S. Application Data
(60) Provisional application No. 63/386,934, filed on Dec. 12, 2022.

(51) Int. Cl. B01D 67/00; B01D 53/22; B01D 63/02; B01D 69/08; B01D 71/02

(52) U.S. Cl. CPC B01D 67/0067; B01D 53/228; B01D 63/023; B01D 69/08; B01D 71/021; B01D 2053/224; B01D 2256/24; B01D 2256/245; B01D 2257/108; B01D 2257/504; B01D 2257/7022; B01D 2313/042; B01D 2323/081

(57) ABSTRACT

Method for making a carbon molecular sieves described herein may include applying an adhesive to exterior surfaces of polymeric hollow fibers at a first end of a plurality of polymeric hollow fibers, wherein the polymeric hollow fibers include polyimide, polyvinylidene chloride, or a combination thereof, and wherein the adhesive includes at least 75 wt. % polyimide, polyvinylidene chloride, or a combination thereof, based on the total weight of the adhesive; curing the adhesive on the exterior surfaces of the polymeric hollow fibers to form a carbon molecular sieve precursor; and pyrolyzing the carbon molecular sieve precursor to form a carbon molecular sieve, wherein the carbon molecular sieve includes a plurality of carbon hollow fibers and a carbonaceous adhesive residue on a first end of the plurality of carbon fibers.

### CROSS-REFERENCE TO RELATED APPLICATIONS

This application claims the benefit of U.S. Provisional Application Ser. No. 63/386,934 filed Dec. 12, 2022, the entire disclosure of which is hereby incorporated herein by reference.

### TECHNICAL FIELD

Embodiments described herein generally relate to carbon molecular sieves and methods for making carbon molecular sieves.

### BACKGROUND

Carbon molecular sieves may be used to separate gas mixtures. Some carbon molecular sieves include a bundle of hollow carbon fibers, and the ends of the bundle of hollow carbon fibers may be sealed together. To separate a gas mixture the ends of the carbon molecular sieve may be sealed to a housing. A gas mixture may be separated when a gas mixture passes through the housing, where some gasses are retained within the housing and other gasses pass through the hollow carbon fibers and out of the housing. The selectivity of such separations may depend, at least in part, on the integrity of the seal between the exterior surfaces of the hollow carbon fibers and the housing. Accordingly, there is a need for improved carbon molecular sieves for use in gas separations.

### SUMMARY

Embodiments of the present disclosure are directed to carbon molecular sieves that may be used in gas separations and method for producing such carbon molecular sieves. Carbon molecular sieves that include a bundle of hollow carbon fibers may be formed by pyrolyzing a bundle of precursor hollow fibers. According to one or more embodiments described herein, at least one end of a bundle of precursor hollow fibers may be sealed with an adhesive to form a carbon molecular sieve precursor. Then the carbon molecular sieve precursor may be pyrolyzed to form a carbon molecular sieve that includes a seal around external surfaces of the carbon hollow fibers on at least one end of the bundle of the bundle of carbon hollow fibers. Applying the adhesive to the precursor hollow fibers before pyrolysis may improve the contact between the adhesive and the precursor hollow fibers, which in turn, may result in an improved seal around the exterior surfaces of the carbon hollow fibers after pyrolysis. This may improve the selectivity of the carbon molecular sieves of one or more embodiments described herein.

According to one or more embodiments described herein, a method for making a carbon molecular sieve may comprise applying an adhesive to exterior surfaces of polymeric hollow fibers at a first end of a plurality of polymeric hollow fibers, wherein the polymeric hollow fibers comprise polyimide, polyvinylidene chloride, or a combination thereof, and wherein the adhesive comprises at least 75 wt. % polyimide, polyvinylidene chloride, or a combination thereof, based on the total weight of the adhesive; curing the adhesive on the exterior surfaces of the polymeric hollow fibers to form a carbon molecular sieve precursor; and pyrolyzing the carbon molecular sieve precursor to form a carbon molecular sieve, wherein the carbon molecular sieve comprises a plurality of carbon hollow fibers and a carbonaceous adhesive residue on a first end of the plurality of carbon fibers.

According to one or more embodiments described herein, a carbon molecular sieve may comprise a plurality of carbon hollow fibers having a first end and a second end, wherein each carbon hollow fiber has a tubular shape comprising an exterior surface and an interior surface and defining a cavity, wherein each carbon hollow fiber comprises a first opening and a second opening; and a carbonaceous adhesive residue on the first end of the plurality of carbon fibers, wherein the carbonaceous adhesive residue directly contacts the exterior surface of each of the plurality of carbon hollow fibers.

Additional features and advantages of the technology disclosed herein will be set forth in the detailed description that follows, and in part will be readily apparent to those skilled in the art from that description or recognized by practicing the technology as described herein, including the detailed description that follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1A schematically depicts a cross-section of a polymeric hollow fiber according to one or more embodiments described herein;

FIG. 1B schematically depicts a cross-section of a polymeric hollow fiber according to one or more embodiments described herein;

FIG. 2 schematically depicts an end of a carbon molecular sieve precursor according to one or more embodiments described herein;

FIG. 3A schematically depicts an end of a carbon molecular sieve according to one or more embodiments described herein;

FIG. 3B schematically depicts a carbon molecular sieve according to one or more embodiments described herein;

FIG. 4 depicts a photograph of carbon molecular sieve precursors according to the embodiments of Example 2; and

FIG. 5 depicts a carbon molecular sieve according to the embodiments of Example 2.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

As described herein, methods of making a carbon molecular sieve include applying an adhesive to exterior surfaces of polymeric hollow fibers on at least a first end of the polymeric hollow fibers. In some embodiments, adhesive may be applied to both ends of the polymeric hollow fibers. The polymeric hollow fibers may comprise polyimide, polyvinylidene chloride, or a combination thereof, and the adhesive comprises at least 75 wt. % polyimide, polyvinylidene chloride, or combinations thereof, based on the total weight of the adhesive. The method may include curing the adhesive on the exterior surfaces of the polymeric hollow fibers to form a carbon molecular sieve precursor and pyrolyzing the carbon molecular sieve precursor to form a carbon molecular sieve. The carbon molecular sieve may comprise a plurality of carbon hollow fibers and a carbonaceous adhesive residue on a first end of the plurality of carbon fibers.

Conventional methods for sealing an end of a plurality of carbon fibers generally include applying an adhesive to hollow carbon fibers, fibers that have already undergone pyrolysis. Without intending to be bound by theory, applying adhesive to carbon fibers may be challenging due to relatively low wettability of carbon fibers by many conventional adhesives. This may cause a seal between the carbon fibers and the adhesive to fail when exposed to temperature and pressure changes, such as the temperature and pressure changes that may occur in processes for separating gas mixtures. However, without intending to be bound by theory, applying an adhesive to a polymeric hollow fiber and subsequently pyrolyzing both the adhesive and the polymeric hollow fiber simultaneously, may result in a carbon molecular sieve with a strong seal between the exterior surfaces of the carbon hollow fibers and the carbonaceous adhesive residue (the material resulting from the pyrolysis of the adhesive). This seal may be able to withstand harsh separation conditions such as high temperatures and pressures, exposure to high and low pH, and exposure to various hydrocarbons that may occur when separating gas mixtures.

Methods for making a carbon molecular sieve described herein may include applying an adhesive to exterior surfaces of a polymeric hollow fibers. In one or more embodiments, the polymeric hollow fibers may comprise polyimide, polyvinylidene chloride, or a combination thereof. For example, without limitation, the polymeric hollow fibers may comprise polyimide; the polymeric hollow fibers may comprise polyvinylidene chloride; or the polymeric hollow fibers may comprise both polyimide and polyvinylidene chloride. As described herein, “polyimide” is a polymer comprising imide groups in the polymer backbone. Any suitable polyimide may be used in the polymeric hollow fibers. Exemplary polyimides for the polymeric hollow fibers are described in International Publication No. WO 2020/154146 A1, the entire contents of which are incorporated by reference herein. Suitable polyimides may include at least two different moieties arising from a diamine and dianhydride monomer selected from 2,4,6-trimethyl-1,3-phenylene diamine (DAM), dimethyl-3,7-diaminodiphenyl-thiophene-5,5′-dioxide (DDBT), 3,5-diaminobenzoic acid (DABA), 5(6)-amino-1-(4-aminophenyl)-1,3,3-trimethylindane (DAPI), 2,3,5,6-tetramethyl-1,4-phenylene diamine (durene), tetramethylmethylenedianaline (TMMDA), 4,4′-diamino 2,2′-biphenyl disulfonic acid (BDSA); 5,5′-[2,2,2-trifluoro-1-(trifluoromethyl)ethylidene]-1,3-isobenzofurandion (6FDA), 3,3′,4,4′-biphenyl tetracarboxylic dianhydride (BPDA), pyromellitic dianhydride (PMDA), 1,4,5,8-naphthalene tetracarboxylic dianhydride (NTDA), and benzophenone tetracarboxylic dianhydride (BTDA). In one or more embodiments, the polyimide comprises at least one of the following diamines: is 2,4,6-trimethyl-1,3-phenylenediamine (DAM), 3,5-diaminobenzoic acid (DABA), 2,3,5,6-tetramethyl-1,4-phenylenediamine (durene), or tetramethylmethylenedianiline (TMMDA). In one or more embodiments, the polyimide may comprise MATRIMID™ 5218 (Huntsman Advanced Materials Americas, The Woodlands, Texas), a commercially available polyimide that is a copolymer of 3,3′,4,4′-benzo-phenonetetracarboxylic acid dianhydride and 5(6)-amino-1-(4′-aminophenyl)-1,3,3-trimethylindane (BTDA-DAPI). In one or more embodiments, the polymeric hollow fibers do not undergo pyrolysis to form carbon hollow fibers before applying the adhesive to the exterior surfaces of the polymeric hollow fibers.

In embodiments, the plurality of polymeric hollow fibers may comprise from 10 to 50,000 polymeric hollow fibers. For example, without limitation, the plurality of polymeric hollow fibers may comprise from 10 to 50,000, from 50 to 50,000, from 100 to 50,000, from 250 to 50,000, from 500 to 50,000, from 1,000 to 50,000, from 5,000 to 50,000, from 10,000 to 50,000 from 20,000 to 50,000, from 30,000 to 50,000, from 40,000 to 50,000, from 10 to 40,000, from 10 to 30,000, from 10 to 20,000, from 10 to 10,000, from 10 to 5,000, from 10 to 1,000, from 10 to 500, from 10 to 250, from 10 to 100, from 10 to 50 or any combination or subset of these ranges. In embodiments, each fiber in the plurality of polymeric hollow fibers may comprise polyimide, polyvinylidene chloride, or a combination thereof.

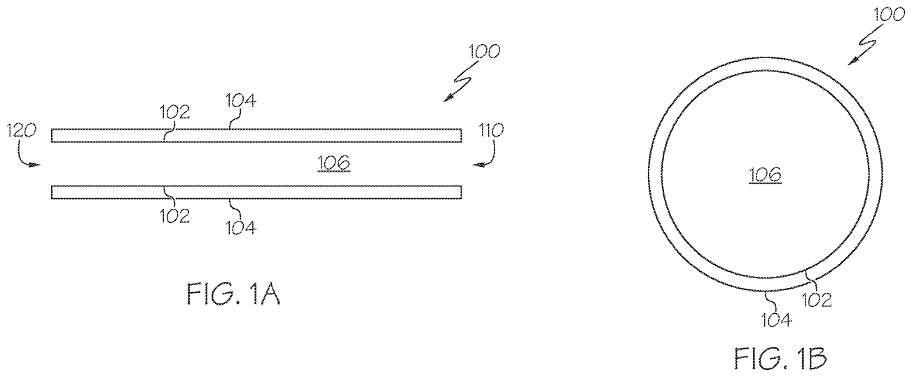

Referring now to FIGS. 1A and 1B, each polymeric hollow fiber 100 may have a tubular shape and may comprise an interior surface 102 and an exterior surface 104. The interior surface 102 may define a cavity 106. In embodiments, each polymeric hollow fiber 100 may have a circular, elliptical, oval, or any other suitable cross-sectional shape. For example, without limitation, the polymeric hollow fiber 100 depicted in FIG. 1B has a circular cross-sectional shape. It should be noted that in some embodiments, the cross-sectional shape may not be perfectly circular, elliptical, or oval due to minor defects in the fibers. Accordingly, in some embodiments, the polymeric hollow fibers 100 may have a substantially circular, elliptical, or oval cross-sectional shape. Each polymeric hollow fiber 100 may have a first end 110 and a second end 120. In embodiments, the first end 110 of each polymeric hollow fiber 100 includes an opening to the cavity 106, and the second end 120 of each polymeric hollow fiber 100 includes an opening to the cavity 106.

Methods for producing carbon molecular sieves described herein include applying an adhesive to exterior surfaces 104 of polymeric hollow fibers 100. The adhesive may be applied to the exterior surfaces 104 of the polymeric hollow fibers 100 by any suitable means, including but not limited to, spraying, brushing, dipping, and pouring, among others. In one or more embodiments, the adhesive may be applied to exterior surfaces 104 of the polymeric hollow fibers 100 at a first end 110 of the plurality of polymeric hollow fibers 100, at a second end 120 of the plurality of polymeric hollow fibers 100, or at both a first end 110 and a second end 120 of the plurality of polymeric hollow fibers 100. It should be noted that the adhesive does not contact the entirety of the exterior surface 104 of the polymeric hollow fibers 100. In embodiments, at least a portion of the exterior surface 104 of the polymeric hollow fibers 100 are not coated by the adhesive. For example, in embodiments where both the first end 110 and the second end 120 of the exterior surfaces 104 of the polymeric hollow fibers 100 are coated with an adhesive, there is a portion of the hollow fibers between the first end 110 and the second end 120 that is uncoated. In embodiments, applying the adhesive to the exterior surfaces 104 of the polymeric hollow fibers 100 does not obstruct or otherwise cover the openings to the cavities 106 of the polymeric hollow fibers with the adhesive. For example, without limitation, the adhesive may not obstruct at least 50%, at least 60%, at least 70%, at least 80%, or even at least 99% of the surface area polymeric hollow fiber openings.

In embodiments, the adhesive may comprise at least 75 wt. % polyimide, polyvinylidene chloride, or combinations thereof, based on the total weight of the adhesive. For example, without limitation, the adhesive may comprise at least 75 wt. %, 80 wt. %, 85 wt. %, 90 wt. %, 95 wt. %, or even 99 wt. %, polyimide, polyvinylidene chloride, or combinations thereof, based on the total weight of the adhesive. In embodiments, the adhesive may consist essentially of or even consist of polyimide, polyvinylidene chloride, or combinations thereof. In one or more embodiments, the adhesive may further comprise polyvinyl acetate. Without intending to be bound by theory, polyvinyl acetate may be added to the adhesive to modulate the viscosity of the adhesive.

In one or more embodiments, both the polymeric hollow fibers 100 and the adhesive comprise polyimide, polyvinylidene chloride, or a combination thereof. For example, the adhesive may comprise at least 75 wt. %, based on the total weight of the adhesive of the polyimide, polyvinylidene chloride, or combination thereof that comprises the plurality of polymeric hollow fibers. For example, without limitation, the adhesive may comprise at least 75 wt. %, 80 wt. %, 85 wt. %, 90 wt. %, 95 wt. %, or even 99 wt. %, based on the total weight of the adhesive, of the polyimide, polyvinylidene chloride, or combination thereof that comprises the plurality of polymeric hollow fibers. Without intending to be bound by theory, when the adhesive comprises at least 75 wt. % of the polyimide, polyvinylidene chloride, or combination thereof comprising the polymeric hollow fibers 100, the wettability of the polymeric hollow fibers 100 with the adhesive may be improved. This may lead to an improved seal forming between the adhesive and the exterior surface of the polymeric hollow fibers.

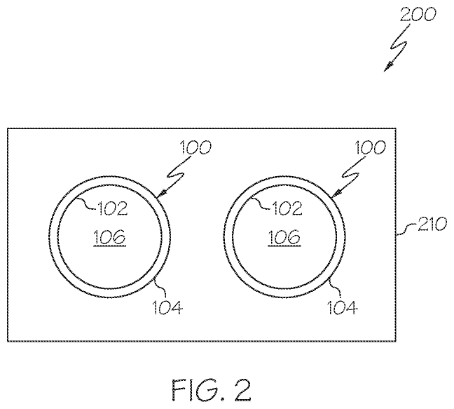

The methods for forming carbon molecular sieves described herein include curing the adhesive on the exterior surfaces 104 of the polymeric hollow fibers 100 to form a carbon molecular sieve precursor. Referring now to FIG. 2, the carbon molecular sieve precursor 200 comprises a plurality of polymeric hollow fibers 100. For the sake of simplicity in the figure, only two polymeric hollow fibers 100 are depicted in FIG. 2. The carbon molecular sieve precursor 200 further comprises a cured adhesive 210. The cured adhesive 210 may directly contact the exterior surfaces 104 of the polymeric hollow fibers 100. In embodiments, the cured adhesive 210 does not obstruct openings to cavity 106 of the polymeric hollow fibers 100. The adhesive on the exterior surfaces of the polymeric hollow fibers 100 may be cured by any suitable means. Without intending to be bound by theory, the curing process may be operable to crosslink the adhesive. Upon crosslinking, the adhesive may have improved structural stability against softening and melting during a subsequent pyrolysis step. In embodiments, curing the adhesive may comprise exposing the adhesive to gamma irradiation, electron beam irradiation, or ultraviolet irradiation or heat.

In one or more embodiments, the adhesive may be cured at a temperature from 120° C. to 160° C. For example, without limitation, curing the adhesive may occur at a temperature from 120° C. to 160° C., from 120° C. to 150° C., from 120° C. to 140° C., from 120° C. to 130° C., from 130° C. to 160° C., from 140° C. to 160° C., from 150° C. to 160° C., or any combination or subset of these ranges.

In one or more embodiments, curing the adhesive may occur for a time from 1 hour to 48 hours. For example, without limitation, curing the adhesive may occur for a time from 1 hour to 48 hours, from 1 hour to 42 hours, from 1 hour to 36 hours, from 1 hour to 30 hours, from 1 hour to 24 hours from 1 hour to 18 hours, from 1 hour to 12 hours, from 1 hour to 6 hours, from 1 hour to 3 hours, from 3 hours to 48 hours, from 6 hours to 48 hours, from 12 hours to 48 hours, from 18 hours to 48 hours, from 24 hours to 48 hours, from 30 hours to 48 hours, from 36 hours to 48 hours, from 42 hours to 48 hours, or any combination or subset of these ranges.

The methods for forming carbon molecular sieves described herein include pyrolyzing the carbon molecular sieve precursor 200 to form a carbon molecular sieve. As described herein, “pyrolysis” refers to the thermal decomposition of a material at elevated temperature under an inert atmosphere. Generally, the products of pyrolysis may be carbon-rich compared to the reactants undergoing pyrolysis. In embodiments, pyrolyzing the carbon molecular sieve precursor may form a carbon molecular sieve. The carbon molecular sieve may have a greater carbon content, based on the weight of the carbon molecular sieve, than the carbon content of the carbon molecular sieve precursor 200, based on the weight of the carbon molecular sieve precursor. Pyrolyzing the carbon molecular sieve precursor 200 may occur in any suitable furnace, oven, or other device operable to heat the carbon molecular sieve temperature to a sufficient temperature for pyrolysis under an inert atmosphere.

In one or more embodiments, pyrolyzing the carbon molecular sieve precursor 200 occurs at a temperature from 500° C. to 1500° C. In this temperature range, pyrolysis of polyimide and PVDC may form permselective carbon molecular sieve membranes. For example, without limitation, pyrolyzing the carbon molecular sieve precursor 200 may occur at a temperature from 500° C. to 1500° C., from 600° C. to 1500° C., from 700° C. to 1500° C., from 800° C. to 1500° C., from 900° C. to 1500° C., from 1000° C. to 1500° C., from 1100° C. to 1500° C., from 1200° C. to 1500° C., from 1300° C. to 1500° C., from 1400° C. to 1500° C., from 500° C. to 1400° C., from 500° C. to 1300° C., from 500° C. to 1200° C., from 500° C. to 1100° C., from 500° C. to 1000° C., from 500° C. to 900° C., from 500° C. to 800° C., from 500° C. to 700° C., from 500° C. to 600° C., or any combination or subset of these ranges. In some embodiments, pyrolyzing the carbon molecular sieve precursor 200 occurs at a temperature from 500° C. to 1000° C. In embodiments, pyrolyzing the carbon molecular sieve precursor occurs at a temperature from 500° C. to 900° C. Without intending to be bound by theory, when the carbon molecular sieve precursors are pyrolyzed at a temperature from 500° C. to 1500° C. the carbon molecular sieve precursors may form carbon molecular sieve membranes that are operable to separate the species of gas mixtures, such as, but not limited to, separating olefins and alkanes (e.g., propane and propene). Furthermore, the pyrolyzing the carbon molecular sieve precursors at such temperatures may produce permselective carbon molecular sieve membranes.

In one or more embodiments, pyrolyzing the carbon molecular sieve precursor 200 occurs for a time from 1 hour to 1 week. For example, without limitation, pyrolyzing the carbon molecular sieve precursor 200 may occur for a time from 1 hour to 1 week, from 3 hours to 1 week, from 6 hours to 1 week, from 12 hours to 1 week, from 18 hours to 1 week, from 1 day to 1 week, from 2 days to 1 week, from 3 days to 1 week, from 4 days to 1 week, from 5 days to 1 week, from 6 days to 1 week, from 1 hour to 6 days, from 1 hour to 5 days, from 1 hour to 4 days, from 1 hour to 3 days, from 1 hour to 2 days, from 1 hour to 1 day, from 1 hour to 18 hours, from 1 hour to 12 hours, from 1 hour to 6 hours, from 1 hour to 3 hours, or any combination to subset of these ranges. It should be noted that, in some embodiments, pyrolysis may occur for a period of time necessary for the reaction to form a carbon molecular sieve having a pore size distribution that may be suitable for separating gasses from a gas mixture, such as, but not limited to, separating olefins and alkanes (e.g., propane and propene). Furthermore, the pyrolyzing the carbon molecular sieve precursors at such temperatures may produce permselective carbon molecular sieve membranes.

In one or more embodiments, pyrolyzing the carbon molecular sieve precursor 200 occurs under an inert atmosphere. The inter atmosphere may be any suitable inert atmosphere for pyrolysis. In embodiments, the inert atmosphere may be substantially free of an oxidizing species, such as oxygen (O₂). As described herein, a composition is “substantially free” of a component when that component is not intentionally added to the composition; however, it should be noted that the component may be present in small amounts as a contaminant. In embodiments, the inert atmosphere may comprise nitrogen, argon, carbon dioxide, or combinations thereof. In some embodiments, the inert atmosphere may consist essentially of, or even consist of nitrogen, argon, or carbon dioxide. Without intending to be bound by theory, pyrolyzing the carbon molecular sieve precursor 200 may occur under an inert atmosphere to prevent undesired side reactions from occurring, such as but not limited to, combustion and hydrolysis.

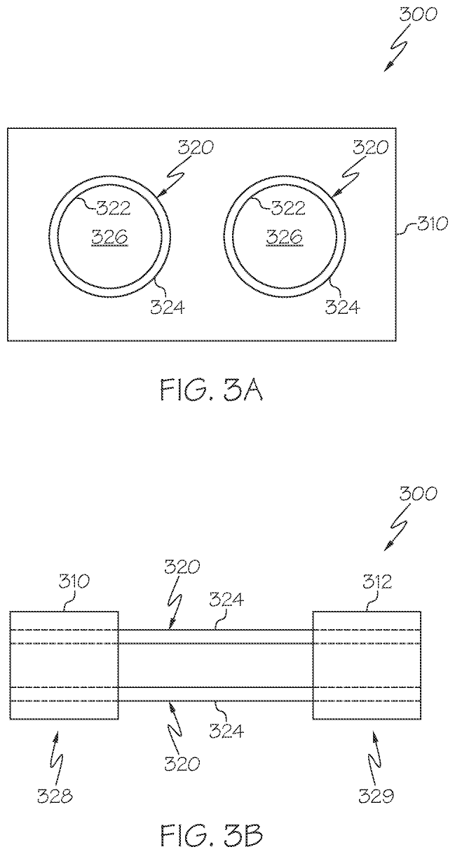

Pyrolyzing the carbon molecular sieve precursor 200 may form a carbon molecular sieve. In embodiments, the carbon molecular sieve may comprise a carbonaceous adhesive residue and a plurality of carbon hollow fibers. In one or more embodiments, the carbonaceous adhesive residue directly contacts at least a portion of an outer surface of each carbon hollow fiber in the carbon molecular sieve. It should be noted that at least a portion of the outer surface of each carbon hollow fiber is not contacted by the carbonaceous adhesive reside. Referring now to FIG. 3A, a carbon molecular sieve 300 comprises a carbonaceous adhesive residue 310 and a plurality of carbon hollow fibers 320. For the sake of simplicity, only two carbon hollow fibers 320 are depicted in FIG. 3A. Each carbon hollow fiber 320 comprises an inner surface 322 and an outer surface 324. The inner surface 322 of the carbon hollow fiber 320 defines a cavity 326.

In embodiments, the direct contact between the carbonaceous adhesive residue 310 and the outer surface 324 of a carbon hollow fiber 320 results in a seal between the carbonaceous adhesive residue 310 and the outer surface 324 of the carbon hollow fiber. This seal may prevent the passage of a gas mixture between the carbonaceous adhesive residue 310 and the outer surface 324 of the carbon hollow fiber 320. Without intending to be bound by theory, reducing the amount of a gas mixture that may pass between the carbonaceous adhesive residue 310 and the exterior surface 324 of the carbon hollow fiber 320 may result in greater selectivity of the carbon molecular sieve 300. In one or more embodiments, the seal between the carbonaceous adhesive residue 310 and the outer surface 324 of the carbon hollow fibers 320 may be sufficiently durable to withstand high temperatures and pressure, exposure to materials having high and low pH values and exposure to various hydrocarbons that may occur during the separation of various gas mixtures.

In embodiments where adhesive was applied to a second end 120 of the outer surfaces of the polymeric hollow fibers 100, the carbon molecular sieve may further comprise a second carbonaceous adhesive residue on a second end of the plurality of carbon hollow fibers 320. The second carbonaceous adhesive residue may directly contact an outer surface 324 of each carbon hollow fiber 320 in the carbon molecular sieve 300. In embodiments, the second carbonaceous adhesive residue does not obstruct openings to the cavities of the carbon hollow fibers 320. In the embodiment depicted in FIG. 3B, the carbon molecular sieve 300 comprises a carbonaceous adhesive residue 310 positioned at the first end 328 of the carbon hollow fibers 320 and a second carbonaceous adhesive residue 312 positioned at the second end 329 of the carbon hollow fibers 320. It should be noted that at least a portion of the outer surface 324 of each carbon hollow fiber 320 is not contacted by the carbonaceous adhesive residue 310 and the second carbonaceous adhesive residue 312.

In one or more embodiments, the carbonaceous adhesive residue 310 does not cover or otherwise obstruct openings to the cavities of the carbon hollow fibers 320. For example, without limitation, the carbonaceous adhesive residue may not obstruct the openings to at least 50%, at least 60%, at least 70%, at least 80%, or even at least 99% of the carbon hollow fibers in the plurality of carbon hollow fibers. Without intending to be bound by theory, having the openings of carbon hollow fibers 320 obstructed by the carbonaceous adhesive residue 310 may reduce the effectiveness of the carbon molecular sieve 300 for separating gas mixtures. When the opening of a carbon hollow fiber 320 is obstructed by the carbonaceous adhesive residue 310, it may not be possible to pass a gas mixture through that carbon hollow fiber 320, reducing the number of carbon hollow fibers 320 in the carbon molecular sieve 300 that are operable for separating gas mixtures.

In embodiments, the carbonaceous adhesive residue 310 may be formed from the adhesive of the carbon molecular sieve precursor 200. In embodiments, a weight of the carbonaceous adhesive residue 310, after pyrolysis at 550° C., is greater than 10 wt. % of the adhesive, based on the total weight of the adhesive. For example, without limitation, the weight of the carbonaceous adhesive residue 310 after pyrolysis at 550° C. is greater than 10 wt. %, 20 wt. %, 30 wt. %, 40 wt. %, or even 50 wt. % of the adhesive, based on the total weight of the adhesive. It should be noted that the pyrolysis occurred for a time necessary for the pyrolysis reaction to reach equilibrium at a temperature of 550° C. Without intending to be bound by theory, when the weight of the carbonaceous adhesive residue 310 after pyrolysis at 550° C. is greater than 10 wt. % of the adhesive, the carbonaceous adhesive residue 310 may provide a seal with the mechanical strength for use in gas separation applications.

In one or more embodiments, pyrolysis of the carbon molecular sieve precursor 200 may result in a carbon molecular sieve 300 where the carbon hollow fibers 320 and the carbonaceous adhesive residue 310 have substantially the same composition. Without intending to be bound by theory this may result in a strong bond between the carbonaceous adhesive residue 310 and the carbon hollow fibers 320.

In one or more embodiments, one or more gasses from gas mixtures, such as mixtures of H₂, CO₂, and CH₄ and mixtures of C₃H₆ and C₃H₈, may be separated by carbon molecular sieves 300 described in embodiments herein. Without intending to be bound by theory, when the carbon molecular sieve 300 comprises a carbonaceous adhesive residue 310 on at least one end of the plurality of the carbon hollow fibers 320, the carbon molecular sieve 300 may be operable for use in at least some gas separations. For example, without limitation, the carbon molecular sieve 300 may be sealed in an enclosure operable to separate one or more gasses from a gas mixture. The carbon molecular sieve 300 may be positioned within an enclosure such that the outer surfaces 324 of the carbon hollow fibers 320 are exposed to an interior of the enclosure and the openings of the carbon hollow fibers 320 are exposed to the exterior of the enclosure. The carbonaceous adhesive residue 310 may form a seal between the carbon hollow fibers 320 and the enclosure to prevent or at least substantially reduce the passage of gas between the enclosure and the exterior surfaces 324 of the carbon hollow fibers 320. A gas mixture may be introduced to the interior of the enclosure, and one or more gasses may pass through the carbon hollow fibers 320 and out at least one of the openings of the carbon hollow fibers 320. The durability of the seal between the carbonaceous adhesive residue 310, the carbon hollow fibers 320, and the enclosure at high temperatures and pressures that may occur in some gas separations may result in improved selectivity of the carbon molecular sieves described herein.

### EXAMPLES

The following examples illustrate features of the present disclosure but are not intended to limit the scope of the disclosure. The following examples discuss the production of a carbon molecular sieves according to one or more embodiments described herein.

### Example 1—Production of Polymeric Hollow Fibers

Polyvinylidene chloride hollow fibers were melt extruded using a continuous extruder equipped with a multifilament die. The outer diameter of the fibers was 164 μm, and the inner diameter of the fibers was 76 μm.

Polyimide-PVDC blend hollow fibers were produced by the method disclosed in Example 6 of International Publication No. WO 2020/154146 A1, the entirety of which is incorporated by reference herein.

### Example 2—Preparation of a Carbon Molecular Sieve

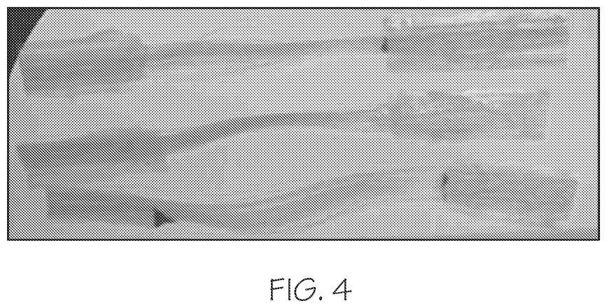

A bundle of 40-50 of the polyvinylidene chloride hollow fibers of Example 1 was taped onto aluminum foil at both ends of the bundle. An adhesive was formed by mixing SL 158 from Owensboro Specialty Polymers, Inc., Owensboro, KY, a water based polyvinlyidene chloride latex, with Elmer's PVA glue in a mass ratio of 4:1. The SL 158 latex was mixed with the glue to thicken the adhesive to a honey like consistency. The adhesive was brushed onto the two ends of the bundle of fibers. The adhesive was applied to about three inches of the bundle of fibers on each end of the bundle of fibers. A middle section of the bundle of fibers, about two inches long, was not coated with the adhesive. The bundle of fibers with the adhesive coating was left to cure for about three days to form a carbon molecular sieve precursor. The carbon molecular sieve precursor is depicted in FIG. 4.

The carbon molecular sieve precursor was positioned between two honeycomb ceramic plates. A piece of Whatman filter paper (Whatman 1003-125) was placed between the carbon molecular sieve precursor and each ceramic plate to cushion the molecular sieve precursor. The carbon molecular sieve precursor was placed in an air purged oven for pretreatment. The flow rate of air was 2 L/min. The temperature of the oven was raised to 130° C. at a rate of 1° C./min. The oven was kept at a temperature of 130° C. for 24 hours to form a pretreated carbon molecular sieve precursor. The pretreated carbon molecular sieve precursor, positioned between the ceramic plates, was removed from the oven, and cooled to a temperature below 60° C.

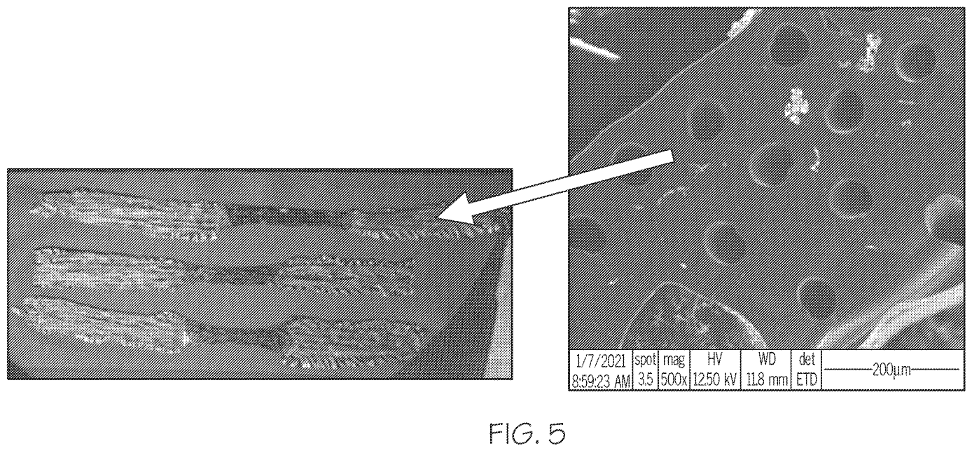

The pretreated carbon molecular sieve precursor, positioned between the ceramic plates, was placed in a quartz tube furnace. The quartz tube furnace had a 6-inch diameter and a length of 24 inches. The quartz tube furnace was purged with nitrogen. The flow rate of the nitrogen was 5 L/min. The quartz tube furnace was raised to a temperature of 250° C. at a rate of 0.1° C./min. Then the quartz tube furnace was raised to a temperature of 550° C. at a rate of 3° C./min. The quartz tube furnace was held at 550° C. for 120 minutes to form a carbon molecular sieve. The quartz tube furnace was allowed to cool, then the carbon molecular sieve was removed from the quartz tube furnace and allowed to cool to a temperature below 60° C. Carbon molecular sieves are depicted in FIG. 5 and a cross section of the end of a carbon molecular sieve where hollow carbon fibers pass through carbonized adhesive residue is also depicted in FIG. 5.

### Example 3—Preparation of a Carbon Molecular Sieve

A carbon molecular sieve was prepared by the method of Example 2 using an adhesive formed by mixing Methocel 4FM, Elmer's PVA glue and SL 158 latex in a weight ratio of 0.2:1:99 respectively.

### Example 4—Preparation of a Carbon Molecular Sieve

A bundle of 8 of the Polyimide-PVDC blend hollow fibers of Example 1 was taped onto aluminum foil at both ends of the bundle. An adhesive was formed by mixing SL 158 from Owensboro Specialty Polymers, Inc., Owensboro, KY, a water based polyvinylidene chloride latex, with Elmer's PVA glue in a mass ratio of 4:1. The SL 158 latex was mixed with the glue to thicken the adhesive to a honey like consistency. The adhesive was brushed onto the two ends of the bundle of fibers. The adhesive was applied to about three inches of the bundle of fibers on each end of the bundle of fibers. A middle section of the bundle of fibers, about two inches long, was not coated with the adhesive. The bundle of fibers with the adhesive coating was left to cure for about three days to form a carbon molecular sieve precursor. A carbon molecular sieve was prepared from the carbon molecular sieve precursor of Example 4 as described in Example 2.

### Example 5-Preparation of a Comparative Carbon Molecular Sieve

A comparative carbon molecular sieve was prepared by the method of Example 2 using J-B Weld Hi-Temp RTV Silicone as the adhesive. The comparative carbon molecular sieve of Example 4 was very brittle, and the ends of the carbon molecular sieve shattered after pyrolysis.

### Example 6—Preparation of a Comparative Carbon Molecular Sieve

A comparative carbon molecular sieve was prepared by the method of Example 2 using Parabond 905 polyurethane as the adhesive. The comparative carbon molecular sieve of Example 5 was very brittle, and the ends of the carbon molecular sieve shattered after pyrolysis.

### Example 7—Preparation of a Comparative Carbon Molecular Sieve

A comparative carbon molecular sieve was prepared by the method of Example 2 using 3M Acrylic DP8407 as the adhesive. The solids yield of the 3M Acrylic DP8407 after pyrolysis at 550° C. was low, at 4.5 wt. % solid residue. Accordingly, a comparative carbon molecular sieve was not formed.

### Example 8—Preparation of a Comparative Carbon Molecular Sieve

A comparative carbon molecular sieve was prepared by the method of Example 2 using 3M Acrylic DP8010 as the adhesive. There was no solid yield of the 3M Acrylic DP8010 after pyrolysis at 550° C. The solids yield was 0 wt. % solid residue. Accordingly, a comparative carbon molecular sieve was not formed.

Table 1 includes information of the adhesive used, the adhesive viscosity, and the adhesive residue after pyrolysis at 550° C. for the carbon molecular sieves of Examples 2-8.

TABLE 1

| Ex- | | Adhesive | Adhesive |
|---|---|---|---|
| am- | | viscosity | residue at |
| ple | Adhesive | [cP] | 550° C. [wt %] |
| 2 | 80 wt % SL158, 20% | 3730 | 28.3% |
| | Elmer's PVA glue | | |
| 3 | 99 wt % SL158, | 5460 | 25.7% |
| | 1 wt % Elmer's | | |
| | PVA glue, 0.02 | | |
| | wt % Methocel | | |
| | 4FM | | |
| 4 | 80 wt % SL158, 20% | 3730 | 28.3% |
| | Elmer's PVA glue | | |
| 5 | J-B Weld Hi-temp | High | 19.6% |
| | RTV Silicone | viscosity | |
| | | paste | |
| 6 | Parabond 905 | High viscosity | 44.2% |
| | | paste | |
| 7 | Acrylic DP8407 | 45,000-55,000 | 4.5% |
| 8 | Acrylic DP8010 | 25,000-35,000 | 0% |

### Example 8—Permeation Testing

A ring permeation cell was used to test the permeation of the carbon molecular sieves of each of Examples 2 and 3. The ring permeation cell had an outer diameter of 5 inches and an inner diameter of 3 inches. The ring permeation cell had four 0.5-inch openings on the wall with SAE/MS 9/16 in. O-ring fittings, and 0.25 in. thick covers at two sides with O-ring seals. Two ends of the carbon molecular sieve were glued onto an aluminum chip using Scotch Weld DP100 epoxy. The dimensions of the aluminum chip were 0.4 in. by 2.0 in. by 0.02 in. The aluminum chip provides mechanical integrity to the carbon molecular sieve.

Pieces of polyolefin heat shrink tape, McMaster-Carr #636k212, having a thickness of 0.03 in. was put on two sides of the carbon molecular sieve. A heat gun was used to shrink the tape to snugly wrap the carbon molecular sieve to the aluminum chip. A two-part epoxy, Scotch Weld DP100, was mixed and applied to the interface between the carbon molecular sieve and the heat shrunk tape to form a seal. The two sides of the heat shrunk tape were inserted into the holes on the side of the ring cell. A dam was made using Teflon tape around the heat shrunk tape inside the hole. Scotch Weld DP100 epoxy was used to fill the hole and form a seal.

The permeation of the carbon molecular sieve was measured in the ring permeation cell. Mixed gasses were fed into the reservoir inside the ring permeation cell. A continuous purge of helium at 10 sccm and 2 psig were used to carry the permeate through the hollow fibers of the carbon molecular sieve membrane to a gas chromatography analysis. The permeate flow rate was calculated using the purge flow rate and the permeate gas concentration measured by the gas chromatograph, normalized by the cross-membrane pressure difference and the total hollow fiber surface area. The total hollow fiber surface area refers to the product of the unsealed length of the fiber, the number of fibers in the carbon molecular sieve, and the outer diameter of the fibers.

Two permeate retention tests were done at low pressure. In the low-pressure tests, the retentate was kept at 0 psig. In the first test, an equimolar mixture of H₂, CO₂, and CH₄ was fed to the ring permeation cell at a temperature of 35° C. In the second test, an equimolar mixture of C₃H₆ and C₃H₈ was fed to the ring permeation cell at a temperature of 35° C.

The low pressure permeate retention tests were performed twice on carbon molecular sieve membranes produced as described in Examples 2 and 3 and once on the carbon molecular sieve membranes produced as described in Example 4. The results of the low pressure permeate retention tests are displayed in Table 2. Specifically, Table 2 includes the permeance of each gas in GPU [1×10⁻⁶ cm³(STP)/(s·cm²·cm Hg)] and the selectivity between gasses. All of the carbon molecular sieves showed good permeance having a H₂ permeance of greater than 150 GPU and a CO₂ permeance of greater than 90 GPU. Additionally, the selectivities of the carbon molecular sieves were good with a CO₂/CH₄ selectivity greater than 40 and a C₃H₆/C₃H₈ selectivity greater than 9. The relatively high selectivities mean that the seals between the fibers in the carbon molecular sieves are defect free.

TABLE 2

| Carbon | | | | | | | |
|---|---|---|---|---|---|---|---|
| Molecular | H₂ | CO₂ | CH₄ | | C₃H₆-35° C. | C₃H₈-35° C. | C₃H₆/C₃H₈ |
| Sieve | [GPU] | [GPU] | [GPU] | CO₂/CH₄ | [GPU] | [GPU] | 35° C. |
| Example 2-1 | 361 | 384 | 8.0 | 48.1 | 14.7 | 1.2 | 11.8 |
| Example 2-2 | 307 | 243 | 3.9 | 61.6 | 8.8 | 0.5 | 18.8 |
| Example 3-1 | NA | NA | NA | NA | 5.6 | 0.3 | 20.8 |
| Example 3-2 | 196 | 146 | 3.4 | 43.1 | 4.9 | 0.4 | 12.8 |
| Example 4 | 660.9 | 756.4 | 26.4 | 28.7 | 31.8 | 5.1 | 6.3 |

According to a first aspect of the present disclosure, a method for making a carbon molecular sieve may comprise applying an adhesive to exterior surfaces of polymeric hollow fibers at a first end of a plurality of polymeric hollow fibers, wherein the polymeric hollow fibers comprise polyimide, polyvinylidene chloride, or a combination thereof, and wherein the adhesive comprises at least 75 wt. % polyimide, polyvinylidene chloride, or a combination thereof, based on the total weight of the adhesive; curing the adhesive on the exterior surfaces of the polymeric hollow fibers to form a carbon molecular sieve precursor; and pyrolyzing the carbon molecular sieve precursor to form a carbon molecular sieve, wherein the carbon molecular sieve comprises a plurality of carbon hollow fibers and a carbonaceous adhesive residue on a first end of the plurality of carbon fibers.

A second aspect of the present disclosure may include the first aspect, wherein the polymeric hollow fibers comprise polyimide.

A third aspect of the present disclosure may include the first aspect, wherein the polymeric hollow fibers comprise polyvinylidene chloride.

A fourth aspect of the present disclosure may include any of the first through third aspects, wherein the plurality of polymeric hollow fibers comprises from 10 to 50,000 polymeric hollow fibers.

A fifth aspect of the present disclosure may include any of the first through fourth aspects, wherein each polymeric hollow fiber comprises an interior surface and an exterior surface, wherein the interior surface defines a cavity.

A sixth aspect of the present disclosure may include the fifth aspect, wherein applying adhesive to the exterior surfaces of the polymeric hollow fibers does not obstruct openings to the cavities of the polymeric hollow fibers.

A seventh aspect of the present disclosure may include any of the first through sixth aspects, wherein the adhesive comprises polyimide.

An eighth aspect of the present disclosure may include any of the first through sixth aspects, wherein the adhesive comprises polyvinylidene chloride.

A ninth aspect of the present disclosure may include any of the first through eighth aspects, wherein the adhesive further comprises polyvinyl acetate.

A tenth aspect of the present disclosure may include any of the first through ninth aspects, wherein both the polymeric hollow fibers and the adhesive comprise polyimide, polyvinylidene chloride, or a combination thereof.

A eleventh aspect of the present disclosure may include any of the first through tenth aspects, wherein the adhesive comprise at least 75 wt. %, based on the total weight of the adhesive, of the polyimide, polyvinylidene chloride, or combination thereof comprising the plurality of polymeric hollow fibers.

A twelfth aspect of the present disclosure may include any of the first through eleventh aspects, wherein curing the adhesive occurs at a temperature from 120° C. to 160° C.

A thirteenth aspect of the present disclosure may include any of the first through twelfth aspects, wherein curing the adhesive occurs for a time from 1 hour to 48 hours.

A fourteenth aspect of the present disclosure may include any of the first through thirteenth aspects, wherein curing the adhesive comprises exposing the adhesive to gamma irradiation, electron beam irradiation, or ultraviolet irradiation.

A fifteenth aspect of the present disclosure may include any of the first through fourteenth aspects, wherein pyrolyzing the carbon molecular sieve precursor occurs at a temperature from 200° C. to 1500° C.

A sixteenth aspect of the present disclosure may include any of the first through fifteenth aspects, wherein pyrolyzing the carbon molecular sieve precursor occurs at a temperature from 400° C. to 1000° C.

A seventeenth aspect of the present disclosure may include any of the first through sixteenth aspects, wherein pyrolyzing the carbon molecular sieve precursor occurs at a temperature from 500° C. to 900° C.

An eighteenth aspect of the present disclosure may include any of the first through seventeenth aspects, wherein pyrolyzing the carbon molecular sieve precursor occurs for a time from 1 hour to 1 week.

A nineteenth aspect of the present disclosure may include any of the first through eighteenth aspects, wherein pyrolyzing the carbon molecular sieve precursor occurs under an inert atmosphere.

A twentieth aspect of the present disclosure may include any of the first through nineteenth aspects, wherein a weight of the carbonaceous adhesive residue after pyrolysis at 550° C. is greater than 10 wt. % of the adhesive, based on the total weight of the adhesive.

A twenty-first aspect of the present disclosure may include any of the first through twentieth aspects, wherein the carbonaceous adhesive residue directly contacts an outer surface of each carbon hollow fiber in the carbon molecular sieve.

A twenty-second aspect of the present disclosure may include any of the first through twenty-first aspects, wherein the carbonaceous adhesive reside does not obstruct openings to cavities of the carbon hollow fibers.

A twenty-third aspect of the present disclosure may include any of the first through twenty-second aspects, wherein the method further comprises applying the adhesive to the outer surfaces of the polymeric hollow fibers at a second end of the plurality of polymeric hollow fibers.

A twenty-fourth aspect of the present disclosure may include the twenty-third aspect, wherein the carbon molecular sieve further comprises a second carbonaceous adhesive residue on a second end of the plurality of carbon hollow fibers.

A twenty-fifth aspect of the present disclosure may include any of the twenty-third through twenty-fourth aspects, wherein the second carbonaceous adhesive residue directly contacts an outer surface of each carbon hollow fiber in the carbon molecular sieve.

A twenty-sixth aspect of the present disclosure may include any of the twenty-third through twenty-fifth aspects, wherein the second carbonaceous adhesive reside does not obstruct openings to cavities of the carbon hollow fibers.

According to a twenty-seventh aspect of the present disclosure, a carbon molecular sieve may comprise a plurality of carbon hollow fibers having a first end and a second end, wherein each carbon hollow fiber has a tubular shape comprising an exterior surface and an interior surface and defining a cavity, wherein each carbon hollow fiber comprises a first opening and a second opening; and a carbonaceous adhesive residue on the first end of the plurality of carbon fibers, wherein the carbonaceous adhesive residue directly contacts the exterior surface of each of the plurality of carbon hollow fibers.

A twenty-eighth aspect of the present disclosure may include the twenty-seventh aspect, wherein the carbonaceous adhesive residue does not obstruct the first opening of at least 50% carbon hollow fibers.

A twenty-ninth aspect of the present disclosure may include any of the twenty-seventh through twenty-eighth aspects, wherein the carbonaceous adhesive residue does not obstruct the first opening of each of the plurality of carbon hollow fibers.

A thirtieth aspect of the present disclosure may include any of the twenty-seventh through twenty-ninth aspects, wherein a composition of the plurality of carbon hollow fibers is substantially the same as a composition of the carbonaceous adhesive residue.

A thirty-first aspect of the present disclosure may include any of the twenty-seventh through thirtieth aspects, wherein the carbon molecular sieve further comprises a second carbonaceous adhesive residue on a second end of the plurality of carbon hollow fibers.

A thirty-second aspect of the present disclosure may include the thirty-first aspect, wherein the second carbonaceous adhesive residue directly contacts the outer surface of each of the plurality of carbon hollow fibers.

A thirty-third aspect of the present disclosure may include any of the thirty-first through thirty-second aspects, wherein the second carbonaceous adhesive residue does not obstruct the second opening of at least 50% carbon hollow fibers.

A thirty-fourth aspect of the present disclosure may include any of the thirty-first through thirty-third aspects, wherein the second carbonaceous adhesive reside does not obstruct the second opening of each of the plurality of carbon hollow fibers.

A thirty-fifth aspect of the present disclosure may include any of the thirty-first through thirty-fourth aspects, wherein the carbonaceous adhesive residue is spaced apart from the second carbonaceous adhesive residue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists of” or “consists essentially of” that second component. Additionally, the term “consisting essentially of” is used in this disclosure to refer to quantitative values that do not materially affect the basic and novel characteristic(s) of the disclosure. For example, a chemical composition “consisting essentially of” a particular chemical constituent or group of chemical constituents should be understood to mean that the composition includes at least about 99.5% of a that particular chemical constituent or group of chemical constituents.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

1. A method of making a carbon molecular sieve, the method comprising:
applying an adhesive to exterior surfaces of polymeric hollow fibers at a first end of a plurality of polymeric hollow fibers, wherein the polymeric hollow fibers comprise polyimide, polyvinylidene chloride, or a combination thereof, and wherein the adhesive comprises at least 75 wt. % polyimide, polyvinylidene chloride, or a combination thereof, based on the total weight of the adhesive;
curing the adhesive on the exterior surfaces of the polymeric hollow fibers to form a carbon molecular sieve precursor; and
pyrolyzing the carbon molecular sieve precursor to form a carbon molecular sieve, wherein the carbon molecular sieve comprises a plurality of carbon hollow fibers and a carbonaceous adhesive residue on a first end of the plurality of carbon fibers.

2. The method of claim 1, wherein the polymeric hollow fibers comprise polyimide.

3. The method of claim 1, wherein the polymeric hollow fibers comprise polyvinylidene chloride.

4. The method of claim 1, wherein the adhesive comprises polyimide.

5. The method of claim 1, wherein the adhesive comprises polyvinylidene chloride.

6. The method of claim 1, wherein the adhesive comprises at least 75 wt. %, based on the total weight of the adhesive, of the polyimide, polyvinylidene chloride, or combination thereof comprising the plurality of polymeric hollow fibers.

7. The method of claim 1, wherein pyrolyzing the carbon molecular sieve precursor occurs at a temperature from 200° C. to 1500° C. for a time from 1 hour to 1 week under an inert atmosphere.

8. The method of claim 1, wherein a weight of the carbonaceous adhesive residue after pyrolysis at 550° C. is greater than 10 wt. % of the adhesive, based on the total weight of the adhesive.

9. The method of claim 1, wherein the carbonaceous adhesive residue directly contacts an outer surface of each carbon hollow fiber in the carbon molecular sieve.

10. The method of claim 1, wherein the polymeric hollow fibers do not undergo pyrolysis before applying the adhesive to the exterior surfaces of the polymeric hollow fibers.

11. The method of claim 1, wherein the method further comprises applying the adhesive to the outer surfaces of the polymeric hollow fibers at a second end of the plurality of polymeric hollow fibers.

12. The method of claim 11, wherein the carbon molecular sieve further comprises a second carbonaceous adhesive residue on a second end of the plurality of carbon hollow fibers.

13. A carbon molecular sieve comprising:
a plurality of carbon hollow fibers having a first end and a second end, wherein each carbon hollow fiber has a tubular shape comprising an exterior surface and an interior surface and defining a cavity, wherein each carbon hollow fiber comprises a first opening and a second opening; and
a carbonaceous adhesive residue on the first end of the plurality of carbon fibers, wherein the carbonaceous adhesive residue directly contacts the exterior surface of each of the plurality of carbon hollow fibers.

14. The carbon molecular sieve of claim 13, wherein a composition of the plurality of carbon hollow fibers is substantially the same as a composition of the carbonaceous adhesive residue.

15. The carbon molecular sieve of claim 13, wherein the carbon molecular sieve further comprises a second carbonaceous adhesive residue on a second end of the plurality of carbon hollow fibers.
